(19) United States
(12) Patent Application Publication
(10) Pub. No.: US 2021/0212086 A1
(43) Pub. Date: Jul. 8, 2021

(54) DEVICES AND METHODS FOR COMMUNICATION IN A WIRELESS COMMUNICATION NETWORK

(71) Applicant: HUAWEI TECHNOLOGIES CO., LTD., Shenzhen (CN)

(72) Inventors: Zhongfeng LI, Shanghai (CN); Richard STIRLING-GALLACHER, Munich (DE); Markus Martin DILLINGER, Munich (DE); Jian LUO, Munich (DE); Serkan AYAZ, Munich (DE); Jian LI, Shanghai (CN)

(21) Appl. No.: 17/206,833

(22) Filed: Mar. 19, 2021

Related U.S. Application Data
(63) Continuation of application No. PCT/EP2018/075686, filed on Sep. 21, 2018.

(51) Int. Cl. H04W 72/12; H04L 1/18; H04W 72/14

(52) U.S. Cl. CPC H04W 72/1242; H04W 72/14; H04W 72/1289; H04L 1/1812

(57) ABSTRACT

Embodiments of the present disclosure disclose example user equipment and a base station for communication in a wireless communication network. One example user equipment includes at least one processor performing operations that include: receiving, by the user equipment, configuration information from a base station using a first communication resource. A communication configuration of the user equipment is defined by the configuration information using a second communication resource. The communication configuration is used for communicating with at least one of the base station or a further user equipment. In the base station case, the configuration information includes at least one of a scheduling request (SR) or a priority configuration. In the further user equipment case, the configuration information includes at least one of BWP configuration, resource pool configuration, QCL configuration, HARQ configuration, preemption configuration, grant configuration, activation configuration, or release configuration.

### CROSS-REFERENCE TO RELATED APPLICATIONS

This application is a continuation of International Application No. PCT/EP2018/075686, filed on Sep. 21, 2018, the disclosure of which is hereby incorporated by reference in its entirety.

### TECHNICAL FIELD

In general, the present disclosure relates to wireless communication networks. More specifically, the present disclosure relates to devices and methods for communication in a wireless communication network.

### BACKGROUND

There is a need for capable V2X (Vehicle to Vehicle, vehicle to infrastructure, vehicle to network, vehicle to pedestrian) or cellular intelligent transportation system (C-ITS) communication systems to support the increasing need for vehicle safety, traffic management and the different levels of assistance for automated driving. There is also a need for wireless communication introduced to support industry automation or industry 4.0. Both V2X and industry 4.0 require low latency and high reliable traffic transmission. To this end several technical problems need to be solved.

In the current NR Rel15 Uu based Ultra Reliable Low Latency Communication (URLLC) transmission is supported in the following way.

For the Uu downlink (DL) channel dynamic multiplexing between URLLC and enhanced mobile broadband (eMBB) is proposed, including a preempted transmission signaling with group common DCI format 2_1 to reduce the possible simultaneous transmission interference fir intra user equipment (UE) or inter UE and CBG based retransmission with CBGFI for DCI format 1_1 to avoid the polluted intra UE or inter UE CBG for retransmission combination.

For the Uu uplink (EL) transmission, without grant or configured UL grant is proposed to support low latency traffic e.g. URLLC or periodic transmission. The configured grant includes type 1 and type 2. For type 1 the UL resource is configured in radio resource control (RRC) without layer 1 (L1) activation. The UE having received the configuration can transmit UL data e.g. URLLC data according to the configuration unless a new configuration received. For type 2 the UL resource is configured or activated by L1 signaling (RRC can also be used for some parameter configuration), where L1 signaling is required before transmission. The L1 signaling usually is PDCCH. The UE having received the configuration can transmit UL rdata e.g. URLLC data according to the configuration unless a new configuration received.

For the Uu UL to reduce latency an optimized scheduling request (SR) transmission has been proposed. A SR configuration consists of a set of PUCCH resources for SR across different BWPs and cells. For a logical channel, at most one PUCCH resource for SR is configured per BWP. There is a mapping between logical channel, subcarrier spacing, SR ID, SR resource configuration ID, and PUCCH ID.

However, the proposals described above only support Uu based URLLC and eMBB transmission. Solutions for supporting sidelink (SL) URLLC and eMBB transmission, especially low latency URLLC traffic are not known. In particular, there are no solutions for: how to reflect the requirement of URLLC and/or SL in SR transmission; how to support grant based SL transmission and feedback; how to support URLLC when there is ongoing eMBB traffic in SL; and/or how to do SL configured grant transmission to enable low latency SL URLLC transmission.

Thus, there is a need for improved devices and methods for a wireless communication network addressing one or more of the problems mentioned above.

### SUMMARY

It is an object of the disclosure to provide improved devices and methods for a wireless communication network.

The foregoing and other objects are achieved by the subject matter of the independent claims. Further implementation forms are apparent from the dependent claims, the description and the figures.

Generally, embodiments of the disclosure provide solutions for the system design and increased latency problems when SL communication is included. Thus, embodiments of the disclosure support SL data and control transmission considering both Uu and SL with a complete procedure, a simplified procedure with a modified scheduling request (also referred to as “enhanced scheduling request”, i.e. “eSR”), SL scheduling and HARQ transmission, SL preemption, and/or SL grant free transmission. Embodiments of the disclosure are of particular relevance to 5G NR standardization.

In order to describe the different aspects of the disclosure in more detail, the following terms, abbreviations and notations will be used in the following:

UE User Equipment

BS Base Station, gNodeB, eNodeB, transmission and reception point, access point, roadside unit, UE, and the like

V2V Vehicle to vehicle

V2X Vehicle to everything

C-ITS Cellular Intelligent Transportation System

NR New Radio

URLLC Ultra Reliable Low Latency Communication

eMBB Enhanced Mobile Broadband

SL Sidelink

DL Downlink

UL Uplink

DCI Downlink Control Information

CB Code Block

CBG Code Block Group

CBGFI CBG Flush out Information

CBGTI CBG Transmission Information

RRC Radio Resource Control

L1 Layer 1

L2 Layer 2

SR Scheduling Request

PBCH Physical Broadcast Channel

PDCCH Physical Downlink Control Channel

PUCCH Physical Uplink Control Channel

BWP Bandwidth Part

HARQ Hybrid ARQ

BLER Block Error Rate

MCS Modulation and Coding Scheme

TTI Transmit Time interval

SCS Sub-Carrier Spacing

BSR Buffer Status Report

QCL Quasi-Co-Location

TCI Transmission Configuration Indication

SS Synchronization Signal

RS Reference Signal

CSI Channel State Information

CSIRS CSI Reference Signal

SRS Sounding Reference Signal

CS-RNTI Configured Scheduling RNTI

TBS Transport Block Size

DMRS Demodulation Reference Signal

CRC Cyclic Redundancy Check

FDM Frequency Division Multiplexing

According to a first aspect, the disclosure relates to a user equipment configured to receive configuration information from a base station using a first communication resource, wherein the configuration information defines a communication configuration of the user equipment using a second communication resource for communicating, i.e. transmitting and/or receiving data, with: (a) the base station, wherein the configuration information comprises a SR and/or a priority configuration; and/or (b) a further user equipment, wherein the configuration information comprises at least one of the following: time domain resource configuration, BWP configuration, resource pool configuration, repetition configuration, QCL configuration, HARQ configuration, preemption configuration, grant configuration, activation configuration, release configuration.

In a further possible implementation form of the first aspect, the communication configuration received from the base station comprises a setting of a communication parameter including one or more of the following communication parameters: a link usage, a range/value of a target BLER/MCS table, a latency/TTI/SCS range or value, a reliability range or value, an availability range or value, a buffer status range or value.

In a further possible implementation form of the first aspect, the user equipment is configured to transmit a schedule request, SR, message to the base station based on the SR and/or priority configuration information received from the base station.

In a further possible implementation form of the first aspect, the user equipment is configured to encode the communication parameter in the SR message, in particular as a bit sequence and/or by using one or more third communication resources of a plurality of third communication resources for transmitting the SR message to the base station.

In a further possible implementation form of the first aspect, the user equipment is configured to receive from the base station an encoding scheme and/or a correspondence between the communication parameter and the bit sequence and/or the third communication resources and to encode the communication parameter in the SR message on the basis of the encoding scheme and/or the correspondence provided by the base station.

In a further possible implementation form of the first aspect, the configuration information defines the communication configuration of the user equipment using the second communication resource for communicating with the further user equipment, wherein the configuration information comprises one or more of the following: a time domain resource configuration, a SL BWP, a resource pool, a repetition number, a TCI/QCL assumption, a HARQ feedback resource for SI, data and/or a CSI feedback resource for SI, channel in Uu link or another sidelink or in the opposite sidelink, and/or a CB and/or CBG configuration in SL.

In a further possible implementation form of the first aspect, the user equipment is further configured to communicate with the further user equipment using a fourth communication resource, wherein the user equipment is configured to preempt on the basis of the preemption configuration the fourth communication resource and/or to use the second communication resource for communicating with the further user equipment.

In a further possible implementation form of the first aspect, the preemption configuration includes one or more of the following: information on whether SL preemption is enabled or disabled, one or more than one preempted SL resources, one or more than one SL resources for preemption, a SL control and/or data configuration in the preempted resource, a SL preemption request configuration, and/or a SL preemption reporting configuration.

In a further possible implementation form of the first aspect, the configuration information comprises an identifier of the second communication resource.

In a further possible implementation form of the first aspect, the communication configuration received by the user equipment comprises at least one of the following:

a configured grant transmitted in a first resource or in a first SL for the configuration of a second configured grant transmitted in the second communication resource or in the second SL;

a configured RRC grant transmitted in a first SL for the configuration of a second configured RRC grant and/or a second configured PDCCH grant transmitted in the second communication resource or in the second SL;
an activation and/or release for the second configured grant with a first grant and/or a first configured grant;
a timing between the first grant transmitted in the first communication resource or in the Uu link or in the first SL and the second grant transmitted in the second resource or in the second SL for the activation or release of the second grant;
an activation and/or release of a configured PDCCH grant based on the first grant transmitted in the first communication resource or in the Uu link or in the first SL for the second communication resource or the second SL transmission and/or reception;
a HARQ feedback resource for the second SL configured scheduling data transmission in another Uu link or the third SL or in the opposite SL.

According to a second aspect the disclosure relates to a base station configured to transmit configuration information to a user equipment using a first communication resource, wherein the configuration information defines a communication configuration of the user equipment using a second communication resource for communicating with: (a) the base station, wherein the configuration information comprises a SR and/or priority configuration; and/or (b) a further user equipment, wherein the configuration information comprises at least one of the following: BWP configuration, resource pool configuration, QCL configuration, HARQ configuration, preemption configuration, grant configuration, activation configuration, release configuration.

In a further possible implementation form of the second aspect, the communication configuration transmitted to the user equipment comprises a setting of a communication parameter including one or more of the following communication parameters: a link usage, a range/value, of a target BLEB/MCS table, a latency/TTI/SCS range or value, a reliability range or value, an availability range or value, a buffer status range or value.

In a further possible implementation form of the second aspect, the base station is configured to receive a schedule request, SR, message from the user equipment based on the SR and/or priority configuration information transmitted to the user equipment.

In a further possible implementation form of the second aspect, the base station is further configured to decode the communication parameter in the SR message, in particular a bit sequence included in the SR message and/or on the basis of one or more third communication resources of a plurality of third communication resources used for receiving the SR message from the user equipment.

In a further possible implementation form of the second aspect, the base station is configured to provide to the user equipment an encoding scheme and/or a correspondence between the communication parameter and the bit sequence and/or the one or more selected third communication resources for allowing the user equipment to encode the communication parameter in the SR message on the basis of the encoding scheme and/or the correspondence.

In a further possible implementation form of the second aspect, the configuration information defines the communication configuration of the user equipment using the second communication resource for communicating with the further user equipment, wherein the configuration information comprises one or more of the following: a time domain resource, a SL BWP, a TCI/QCL assumption, a repetition number, a HARQ feedback resource for SL data and/or a CSI feedback resource for SL channel in Uu link or another sidelink or in the opposite sidelink, and/or a CB and/or CBG configuration in SL.

In a further possible implementation form of the second aspect, the user equipment is configured to communicate with the further user equipment using a fourth communication resource, wherein the user equipment is configured to preempt on the basis of the preemption configuration the fourth communication resource and/or to use the second communication resource for communicating with the further user equipment.

In a further possible implementation form of the second aspect, the preemption configuration includes one or more of the following: information on whether SL preemption is enabled or disabled, one or more than one preempted SL resources, one or more than one SL resources for preemption, a SL control and/or data configuration in the preempted resource, a SL preemption request configuration, and/or a SL preemption reporting configuration.

In a further possible implementation form of the second aspect, the communication configuration transmitted by the base station comprises at least one of the following:
a configured grant transmitted in a first resource or in a first SL for the configuration of a second configured grant transmitted in the second communication resource or in the second SL;
a configured RRC grant transmitted in a first SL for the configuration of a second configured RRC grant and/or a second configured PDCCH grant transmitted in the second communication resource or in the second SL;
an activation and/or release for the second configured grant with a first grant and/or a first configured grant;
a timing between the first grant transmitted in the first communication resource or in the Uu link or in the first SL and the second grant transmitted in the second resource or in the second SL for the activation or release of the second grant;
an activation and/or release of a configured PDCCH grant based on the first grant transmitted in the first communication resource or in the Uu link or in the first SL for the second communication resource or the second SL transmission and/or reception;
a HARQ feedback resource for the second SL configured scheduling data transmission in another Uu link or the third SL or in the opposite SL.

Details of one or more embodiments are set forth in the accompanying drawings and the description below. Other features, objects, and advantages will be apparent from the description, drawings, and claims.

### BRIEF DESCRIPTION OF THE DRAWINGS

In the following embodiments of the disclosure are described in more detail with reference to the attached figures and drawings, in which:

FIG. 1 is a schematic diagram showing a wireless communication network, including a user equipment according to an embodiment and a base station according to an embodiment;

FIGS. 2a and 2b are signaling diagrams showing different aspects of the disclosure implemented in a user equipment according to an embodiment and a base station according to an embodiment:

FIGS. 3a and 3b are signaling diagrams showing different aspects of the disclosure implemented in a user equipment according to an embodiment and a base station according to an embodiment;

FIG. 4 is a signaling diagram showing different aspects of the disclosure implemented in a user equipment according to an embodiment and a base station according to an embodiment;

FIG. 5 is a signaling diagram showing different aspects of the disclosure implemented in a user equipment according to an embodiment and a base station according to an embodiment;

FIG. 6 is a signaling diagram showing different aspects of the disclosure implemented in a user equipment according to an embodiment and a base station according to an embodiment; and

FIG. 7 is a signaling diagram showing different aspects of the disclosure implemented in a user equipment according to an embodiment and a base station according to an embodiment.

In the following identical reference signs refer to identical or at least functionally equivalent features.

### DETAILED DESCRIPTION OF THE EMBODIMENTS

In the following description, reference is made to the accompanying figures, which form part of the disclosure, and which show, by way of illustration, specific aspects of embodiments of the disclosure or specific aspects in which embodiments of the present disclosure may be used. It is understood that embodiments of the disclosure may be used in other aspects and comprise structural or logical changes not depicted in the figures. The following detailed description, therefore, is not to be taken in a limiting sense, and the scope of the present disclosure is defined by the appended claims.

For instance, it is understood that a disclosure in connection with a described method may also hold true for a corresponding device or system configured to perform the method and vice versa. For example, if one or a plurality of specific method operations are described, a corresponding device may include one or a plurality of units, e.g. functional units, to perform the described one or plurality of method operations (e.g. one unit performing the one or plurality of operations, or a plurality of units each performing one or more of the plurality of operations), even if such one or more units are not explicitly described or illustrated in the figures. On the other hand, for example, if a specific apparatus is described based on one or a plurality of units, e.g. functional units, a corresponding method may include one operation to perform the functionality of the one or plurality of units (e,g. one operation performing the functionality of the one or plurality of units, or a plurality of operations each performing the functionality of one or more of the plurality of units), even if such one or plurality of operations are not explicitly described or illustrated in the figures. Further, it is understood that the features of the various exemplary embodiments and/or aspects described herein may be combined with each other, unless specifically noted otherwise.

The methods, devices and systems described herein may particularly be implemented in wireless communication networks based on 5G New Radio (NR) mobile communication standards and beyond.

Likewise, the methods, devices and systems described herein may also be implemented in wireless communication networks based on mobile communication standards such as LTE, in particular 3G, 4G, 4.5G, and 5G. The methods, devices and systems described herein may also be implemented in wireless communication networks, in particular communication networks similar to WiFi communication standards according to IEEE 802.11. The described devices may include integrated circuits and/or passives and may be manufactured according to various technologies. For example, the circuits may be designed as logic integrated circuits, analog integrated circuits, mixed signal integrated circuits, optical circuits, memory circuits and/or integrated passives.

The devices described herein may be configured to transmit and/or receive radio signals. Radio signals may be or may include radio frequency signals radiated by a radio transmitting device (or radio transmitter or sender). However, devices described herein are not limited to transmit and/or receive radio signals, also other signals designed for transmission in deterministic communication networks may be transmitted and/or received.

The devices and systems described herein may include processors or processing devices, memories and transceivers, i.e. transmitters and/or receivers. In the following description, the term “processor” or “processing device” describes any device that can be utilized for processing specific tasks (or blocks or operations). A processor or processing device can be a single processor or a multi-core processor or can include a set of processors or can include means for processing, A processor or processing device can process software or firmware or applications etc.

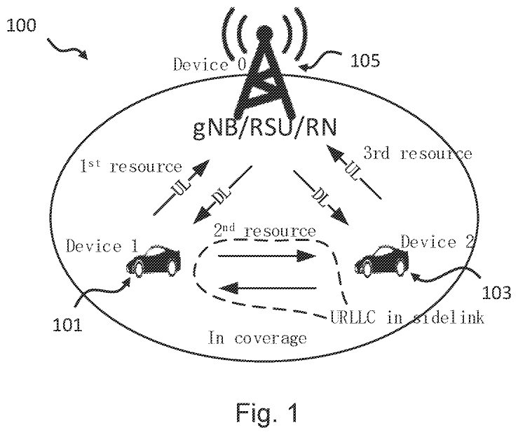

FIG. 1 is a schematic diagram showing a wireless communication network 100. In an embodiment, the wireless communication network 100 can be implemented as a network according to the 5G standard or a standard based thereon. In the exemplary embodiment shown in FIG. 1, the wireless communication network 100 comprises a first user equipment 101, a second user equipment 103 and a base station 105. As illustrated in FIG. 1, the first user equipment 101 is configured to communicate with the base station 105 using a first communication resource or link in an uplink and downlink direction. Likewise, the second user equipment 103 is configured to communicate with the base station 105 using a third communication resource or link in an uplink and downlink direction. The first user equipment 101 and the second user equipment 103 can communicate directly with each other using a second communication resource in a sidelink direction. As will be described in more detail further below, embodiments of the disclosure are particularly suited for providing URLLC sidelink communication.

Although in FIG. 1 the user equipments 101, 103 are illustrated as vehicular UEs, the person skilled in the art will appreciate that embodiments of the disclosure apply to any type of user equipments 101, 103 configured to communicate via an UL and DL with a base station and via a SL with each other, such as user equipments implemented in industry 4.0 scenarios. As used herein, the term “base station” applies to any type of network entity configured to communicate with user equipments via the air interface, such as a gNB, access point, TRP, RSU, relay and the like.

As will be described in more detail below, the first user equipment 101 is configured to receive configuration information from the base station 105 using a first communication resource. The configuration information defines a communication configuration of the first user equipment 101 using a second communication resource for communicating, i.e. transmitting and/or receiving data with: (a) the base station 105, wherein the configuration information comprises a scheduling request, SR, and/or a priority configuration; and/or (b) the second user equipment 103, wherein the configuration information comprises at least one of the following: a time domain resource configuration, a BWP configuration, resource pool configuration, a repetition configuration, a QCL configuration, a HARQ configuration, a preemption configuration, a grant configuration, an activation configuration, a release configuration.

Likewise, the base station 105 is configured to transmit configuration information to the first user equipment 101 using the first communication resource. The configuration information defines a communication configuration of the user equipment 101 using the second communication resource for communicating with: (a) the base station 105, wherein the configuration information comprises a SR and/or priority configuration; and/or (b) the second user equipment 103, wherein the configuration information comprises at least one of the following: time domain resource configuration, MVP configuration, resource pool configuration, repetition configuration, QCL configuration, HARQ configuration, preemption configuration, grant configuration, activation configuration, release configuration.

in an embodiment, the communication configuration received from the base station 105 can comprise a setting of a communication parameter for the communication using the second communication resource including one or more of the following communication parameters: a. link usage, a range/value of a target BLER/MCS table, a latency/TTI/SCS range or value, a reliability range or value, an availability range or value, a buffer status range or value,

In an embodiment, the first user equipment 101 is configured to transmit a schedule request, SR, message to the base station 105 based on the SR and/or priority configuration information received from the base station 105.

In an embodiment, the first user equipment 101 is configured to encode the communication parameter in the SR message, in particular as a bit sequence and/or by using one or more third communication resources of a plurality of third communication resources for transmitting the SR message to the base station 105.

In an embodiment, the user equipment 101 is configured to receive from the base station 105 an encoding scheme and/or a correspondence scheme between the communication parameter and the bit sequence and/or the third communication resources and to encode the communication parameter in the SR message on the basis of the encoding scheme and/or the correspondence scheme provided by the base station 105.

In an embodiment, in case the configuration information defines the communication configuration of the user equipment 101 using the second communication resource for communicating with the second user equipment 103, the configuration information can comprise one or more of the following: a time domain resource, a SL BWP, a resource pool, a repetition number, a TCI/QCL assumption, a HARQ feedback resource for SL data and/or a CSI feedback resource for SL channel in Uu link and/or another sidelink or in the opposite sidelink, and/or a CB and/or CBG configuration in SL.

In an embodiment, the user equipment 101 is further configured to communicate with the second user equipment 103 using a fourth communication resource, such as a communication resource associated with an eMBB communication mode, wherein the user equipment 101 is configured to preempt on the basis of the preemption configuration the fourth communication resource, e.g. a communication resource associated with an eMBB communication mode, to use the second communication resource, e.g. a communication resource associated with the URLLC communication mode, for communicating with the second user equipment 103.

In an embodiment, the preemption configuration can include one or more of the following: information on whether SL preemption is enabled or disabled, one or more than one preempted SL resources, one or more than one SL resources for preemption, a SL control and/or data configuration in the preempted resource, a SL preemption request configuration, and/or a SL preemption reporting configuration.

In an embodiment, the configuration information can comprise an identifier of the second. communication resource.

In an embodiment, the communication configuration received by the user equipment 101 from the base station 105 comprises at least one of the following:
a configured grant transmitted in a first resource or in a first SL for the configuration of a second configured grant transmitted in the second communication resource or in the second SL;
a configured RRC grant transmitted in a first SL for the configuration of a second configured RRC grant and/or a second configured PDCCH grant transmitted in the second communication resource or in the second SL;
an activation and/or release for the second configured grant with a first grant and/or a first configured grant;
a timing between the first grant transmitted in the first communication resource or in the Uu link or in the first SI, and the second grant transmitted in the second resource or in the second SL for the activation or release of the second grant;
an activation and/or release of a configured PDCCH grant based on the first grant transmitted in the first communication resource or in the Uu link or in the first SL for the second communication resource or the second SL transmission and/or reception; and/or
a HARQ feedback resource for the second SL configured scheduling data transmission in another Uu link or the third SL or in the opposite SL.

In the following further embodiments and details of the first user equipment 101 (also referred to as first UE or UE1), the second user equipment 103 (also referred to as second UE or UE2) and the base station 105 (also referred to as gNB in the figures) will be described.

Embodiments of the disclosure provide solutions for a grant based URLLC transmission in the SL. To this end, embodiments of the disclosure make use of a SL SR transmission. To meet the URLLC low latency and high reliability requirements, when URLLC is to he transmitted in SL, the SL SR message preferably carries as much information as possible for the scheduling by the base station 105. Depending on the application scenario, according to embodiments of the disclosure some communication parameters or requirements may be limited to certain ranges, e.g. a reliability requirement range, a latency requirement range, payload size range and the like. As already described above, the UE 101 can receive the configuration information, including certain preconfigured parameters, such as link usage, the range/value of target BLEB/MCS table, a latency/TTI/SCS range or value, a reliability range or value, an availability range or value, a buffer status range or value, a synchronization accuracy, a positioning accuracy and/or a cycle time. Then, according to embodiments of the disclosure the UE 101 can provide such requirement with a low overhead SR message to the base station 105 with low latency. The base station 105, in turn, can do the subsequent scheduling taking these requirements into account. For example, when the required target BLER is low, some diversity scheme can be considered by the base station. When the latency requirement is strict, some low latency scheme can be considered in the following configuration.

As already described above, according to embodiments of the disclosure there can be a pre-configuration or with received signaling for the UE 101 to get the configuration defining one or more of the following: the link usage, the range/value of target BLER/MCS table, the latency/TTI/SCS range or value, the reliability range or value, the availability range or value, the buffer status range or value, the synchronization accuracy, the positioning accuracy, the cycle time and the like. For example, the possible target BLER range can be: <=1e-2, <=1e-3, <=1e-4, <=1e-5, <=1e-6, <=1e-9. The possible latency range can be: <=0.5 ms, <=1 ms, <=2 ms, <=3 ms.

As already described above, a mapping or correspondence between a SR bit status or a SR resource and configuration information, in particular SR or priority information can be predefined or configured. According to embodiments of the disclosure, the configuration information, in particular SR or priority information defines one or more of the following: a link usage, the range/value of target BLER/MCS table, the latency/TTI/SCS range or value, the reliability range or value, the availability range or value, the buffer status range or value, the synchronization accuracy, the positioning accuracy, and/or the cycle time.

For example, the current BSR table can be fixed and defined in one or two large tables, which require 5 or 6 or 8 BSR bits for reporting to the base station 105. According to embodiments of the disclosure, this data can be implemented as a high layer MAC CE signaling carried with PUSCH.

In many industrial scenarios, the packet size is typically limited to certain ranges. By signaling the TBS or BSR range or value, the amount/number of required bits and/or resources can be significantly reduced or a finer granularity of the BSR. can be achieved with a similar or less signaling overhead. According to embodiments of the disclosure, the low overhead request information can be carried with PHY signaling, e.g. SR or PUCCH resources as shown in tables 1 and 2 below. The signaled TBS or BSR range can be a subset of the current TBS table or BSR table or can include independent TBS or BSR range or values.

TABLE 1
Bit field indication of BSR range

| Bits field | Description |
|---|---|
| 00 | BSR range 1 |
| 01 | BSR range 2 |
| 10 | BSR range 3 |
| 11 | BSR range 4 |

TABLE 2
PUCCH resource indication of BSR range

| Resource field | Description |
|---|---|
| Resource0 | BSR range 1 |
| Resource1 | BSR range 2 |
| Resource2 | BSR range 3 |
| Resource3 | BSR range 4 |

According to embodiments of the disclosure, the UE 101 can transmit configuration information, such as SR information and/or priority information, in an encoded form based on the predefined or configured correspondence with a dedicated SR bit status or dedicate SR resources or a PUCCH resource or any combination of them. Based on the indicated information on link usage and/or reliability and/or latency and/or buffer status and/or TBS extracted from the SR message, the base station 105 can select a suitable control/data transmission scheme such as SL control/data indication, cross link cooperation, preemption, configured grant transmission, and the like.

Table 3 below illustrates that according to embodiments of the disclosure different latency ranges can be represented by SR transmission using a subset of available communication resources. Note for each resource, when a positive SR is transmitted, it means there is a scheduling request or resources are required, When no SR is transmitted or received, it means no scheduling request or no resource request.

TABLE 3
Information in SR message: Latency

| Resource field | Latency |
|---|---|
| Resource0 | Latency range 1 |
| Resource1 | Latency range 2 |
| Resource2 | Latency range 3 |
| Resource3 | Latency range 4 |

Table 4 below illustrates that according to embodiments of the disclosure different latency ranges can be represented by SR transmission using different SR bit sequences. Note when no valid bit sequence is detected or no SR message is transmitted, it means no scheduling request or no resource request. When a positive SR is transmitted or detected according to the predefined bit sequence/status and latency range, it means there is a scheduling request or communication resources required by the UE 101 as well as the corresponding required latency range.

TABLE 4
Information in SR message: Latency

| Bit field | Latency |
|---|---|
| 00 | Latency range 1 |
| 01 | Latency range 2 |
| 10 | Latency range 3 |
| 11 | Latency range 4 |

Table 5 below illustrates that according to embodiments of the disclosure different link usage can be represented by SR transmission using different communication resources, as already described above. Note when no valid bit sequence/field is detected or no SR is transmitted, it means that there is no scheduling request or no resource request. When a positive SR message is transmitted or detected according to the predefined resources and link usage, it means there is scheduling request or resources required as well as the corresponding requested link, Note the number of SL or the hop number of SL can also be carried in the SR message.

TABLE 5
Information in SR message: Link usage

| Resource field | Link usage |
|---|---|
| Resource0 | Uu/1st SL |
| Resource1 | SL/2nd SL |

Table 6 below illustrates that according to embodiments of the disclosure different latency ranges, reliability ranges and/or link usage combinations can be represented by a SR transmission using different communication resources. Note that, when no valid bit status is detected or no SR transmitted, it means no scheduling request or no resource request. When a positive SR is transmitted or detected according to the predefined or preconfigured resource and link usage, it means there is scheduling request or resources required and also the corresponding required latency and reliability range and requested link.

TABLE 6
Information in SR message: Latency, reliability & link usage

| Bits/Resource field | Latency | Reliability | Link usage |
|---|---|---|---|
| Resource0 | Latency range 1 | Reliability range1 | Uu/1st SL |
| Resource1 | Latency range 2 | Reliability range2 | Uu/1st SL |
| Resource2 | Latency range 1 | Reliability range1 | SL/2nd SL |
| Resource3 | Latency range 2 | Reliability range2 | SL/2nd SL |

Table 7 below illustrates that according to embodiments of the disclosure different buffer size/buffer status ranges or values and link usage combinations can be represented, i.e. encoded by SR transmission using different communication resources and/or different bit fields/sequences. Note, when no valid bit status is detected or no SR transmitted, it means no scheduling request or no resource request. When a SR is transmitted or detected according to the predefined resource or hit status and link usage and BSR information, it means there is scheduling request or resources required and also the corresponding requested BSR and requested link.

TABLE 7
Information is SR message: Buffer status and link usage

| Bits field/Resource field | BSR | Link usage |
|---|---|---|
| 000/Resource0 | BSR range 1 | Uu/1st SL |
| 001/Resource1 | BSR range 2 | Uu/1st SL |
| 010/Resource2 | BSR range 3 | Uu/1st SL |
| 011/Resource3 | BSR range 4 | Uu/1st SL |
| 100/Resource4 | BSR range 1 | SL/2nd SL |
| 101/Resource5 | BSR range 2 | SL/2nd SL |
| 110/Resource6 | BSR range 3 | SL/2nd SL |
| 111/Resource7 | BSR range 4 | SL/2nd SL |

Table 8 below illustrates that according to embodiments of the disclosure different buffer size/buffer status ranges and latencies and reliability combinations can be represented by a SR transmission using different communication resources or different bit fields/sequences. Note that, when no valid bit status is detected or no SR transmitted, it means no scheduling request or no resource request. When a SR is transmitted or detected according to the predefined communication resource or hit status/field/sequence and latency and reliability and BSR information, it means there is a scheduling request or resources required as well as the corresponding requested BSR and the latency and reliability.

TABLE 8
Information in SR message: Buffer status, latency & reliability

| Bits field/Resource field | BSR | Latency & reliability |
|---|---|---|
| 000/Resource0 | BSR range 1 | Range 1 |
| 001/Resource1 | BSR range 2 | Range 1 |
| 010/Resource2 | BSR range 3 | Range 1 |
| 011/Resource3 | BSR range 4 | Range 1 |
| 100/Resource4 | BSR range 1 | Range 2 |
| 101/Resource5 | BSR range 2 | Range 2 |
| 110/Resource6 | BSR range 3 | Range 2 |
| 111/Resource7 | BSR range 4 | Range 2 |

Table 9 below illustrates that according to embodiments of the disclosure different buffer size/buffer status ranges and link usage, latency and/or reliability combinations can be represented by a SR transmission using different communication resources and/or different bit fields/sequences. Note that, when no valid bit field/sequence is detected or no SR transmitted, it means no scheduling request or no resource request. When the SR message is transmitted or detected according to the predefined resource or bit filed/sequence and link usage and BSR and latency and/or reliability information, it means there is a scheduling request or resources required and also the corresponding requested BSR, requested link and the required latency and reliability.

TABLE 9
Information in SR message: Buffer status, link usage, latency & reliability

| Bits field/Resource field | BSR | Link usage | Latency & reliability |
|---|---|---|---|
| 000/Resource0 | BSR range 1 | Uu/1st SL | Range 1 |
| 001/Resource1 | BSR range 2 | Uu/1st SL | Range 1 |
| 010/Resource2 | BSR range 1 | Uu/1st SL | Range 2 |
| 011/Resource3 | BSR range 2 | Uu/1st SL | Range 2 |
| 100/Resource4 | BSR range 1 | SL/2nd SL | Range 1 |
| 101/Resource5 | BSR range 2 | SL/2nd SL | Range 1 |
| 110/Resource6 | BSR range 1 | SL/2nd SL | Range 2 |
| 111/Resource7 | BSR range 2 | SL/2nd SL | Range 2 |

On the basis of the enhanced SR configuration information and transmission provided by embodiments of the disclosure, latency can be reduced and reliability and resource efficiency may be enhanced.

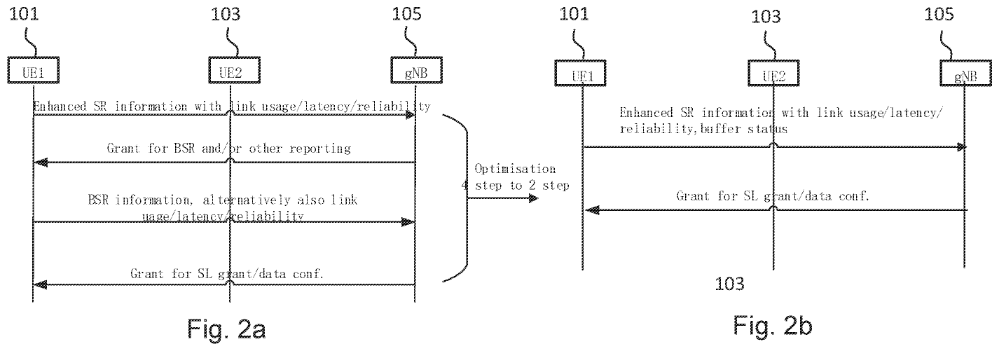

According to embodiments of the disclosure the priority information can be carried by the SR message or transmitted together with a BSR message. Two corresponding embodiments of the disclosure are illustrated in FIGS. 2a and 2b.

FIG. 2a illustrates a procedure implemented by embodiments of the disclosure, which involves four main operations from the transmission of the SR to scheduling grant configuration. For this case, the enhanced SR information or priority information, i.e. configuration information including, for instance, link usage, latency and/or reliability, can be contained in the SR message from the UE 101 to the base station 105 using, for instance, any of the encoding schemes described above (see first operation of FIG. 2a). Alternatively or additionally, the configuration information can be transmitted together with a BSR message (see third operation of FIG. 2a).

In the embodiment shown in FIG. 2b the procedure comprises only two operations from the SR transmission to scheduling grant configuration. In this embodiment, the configuration information, i.e. enhanced SR information including, for instance, link usage, latency, reliability, and/or buffer status information, can be carried in the SR message from the UE 101 to the base station 195 (see first operation of FIG. 2b). In response thereto, based on the configuration information contained in the SR message, the base station 105 can configure the grant e.g. for SL grant and/or data (see second operation of FIG. 2b).

When SL SR and/or BSR is transmitted from the 101 UE and received by the base station 105, as illustrated in FIGS. 2a and 2b. according to embodiments of the disclosure the base station 105 can configure both SL control and data transmission parameters via cross link indication, such as a Uu link indicating SL or the 1st SL indicating the 2nd SL. According to embodiments of the disclosure, the cross link configuration parameters generally can include one or more of the following: a SL frequency configuration, a SL time configuration, a SL resource pool configuration, a SL repetition configuration, a SL QCL assumption for the control channel, a SL QCL assumption for the data channel, whether including CBGTI and/or CBGFI for SL DCI, and/or a SI, HARQ feedback resource configuration.

More specifically, according to embodiments of the disclosure the SL frequency configuration can include a SL BWP and/or carrier indication and/or SL frequency hopping. The transmitter and the receiver may have different BWP capabilities, e.g. one could support wideband or multiple BWP, while the other one could only support narrow band BWP or a small number of BWP. To this end, the cross link signaling, e.g. Uu link can indicate the SL BWP resource configuration using the configuration information, as already described above. The SL BWP configuration can include DL BWP and/or UL BWP configuration. In case FDM between Uu link and SL is supported, the same BWP or shared BWP can be configured for Lu link and SL. According to embodiments of the disclosure, the UE 101 may use all the DL BWP configuration for SL or UL BWP configuration for SL or DL BWP configuration for SL reception and UL BWP configuration for SL transmission. The SL BWP may reuse the point A of Uu link as SL common resource point for a resource block grid, which is suitable for the shared BWP with Uu link case.

According to embodiments of the disclosure, the SL time configuration can includes a SL transmission time, a SL receiving time and/or a SL monitoring time. The SL transmission time can include the flexible symbols configured in the Uu link or another SL, and/or the DL symbols configured in the Uu link or another SL, and/or the UL symbols configured in the Uu link or another SL. The SL reception time can include the flexible symbols configured in the Uu link or another SL and/or the DL symbols configured in the Uu link or another SL and/or the UL symbols configured in the Uu link or another SL. The SL time configuration may override the tdd-UL-DL-ConfigurationCommon, or tdd-UL-DL-ConfigurationCommon2, or tdd-UL-DL-ConfigDedicated configuration. These configurations may be received via the Uu link by the UE 101. The SL transmission time or reception time can be configured directly in the Uu link. Alternatively, the signaling can be transmitted in both Uu and SL.

According to embodiments of the disclosure, the SI, resource pool configuration can include one or more than one resource pool for SL communication. The SL resource pool includes both time and frequency domain resource. The frequency resource of SL resource pool can be within BWP which usually defines UE's radio frequency capability.

According to embodiments of the disclosure, the SL repetition configuration can include SL control repetition and/or SL data repetition. To meet the low latency and reliability requirements of URLLC, repetition may be configured for both SL control and data based on cross link or Uu link configuration. One or more than one of the repetition number, time and frequency resources, QCL assumptions for each transmission in the repetition can be be configured.

According to embodiments of the disclosure, the SL beam or QCL assumption configuration can include a SL TCI configuration, a SL control and/or data channel QCL assumption with SL SS, or SL RS or SL CSIRS or SL SRS.

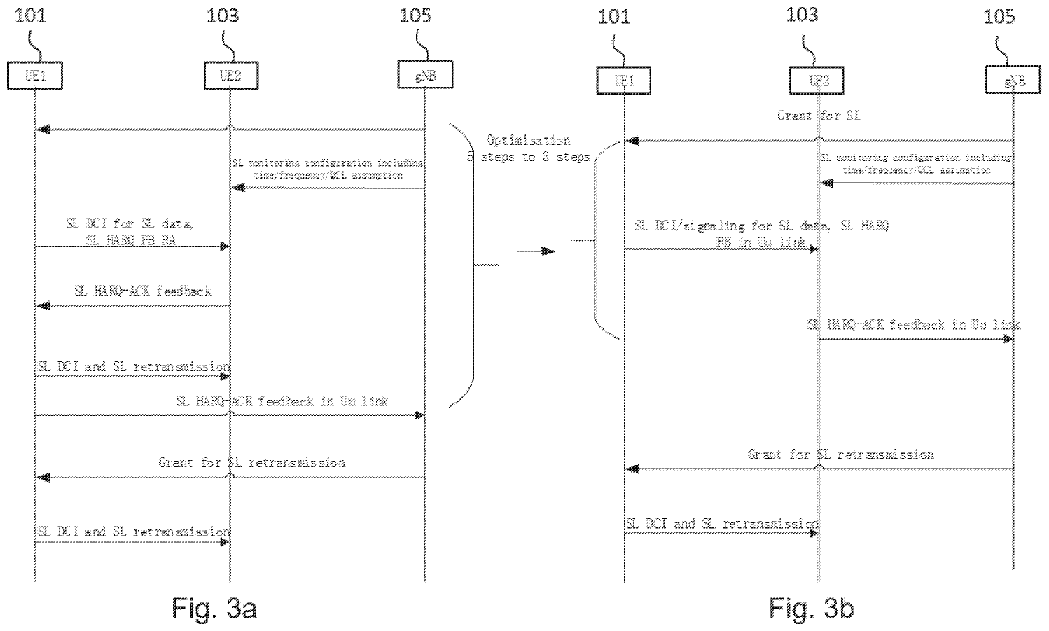

According to embodiments of the disclosure, the SL HARQ and/or CSI feedback resource configuration can include a SL feedback resource configuration in the opposite direction of SL or in SL UL or in the reverse SL and/or a SL feedback resource configuration in another Uu link or in the second Uu link or in the third SL, as will be described in more detail in the following under reference to FIGS. 3a and 3b.

For the SL feedback resource configuration in the opposite direction of the SL, as shown in FIG. 3a, the SL feedback is transmitted in the opposite direction of the SL data transmission. And also the SL data transmitter, e.g. the UE 101, can feedback the SL HARQ ACK or NACK information to the scheduled equipment, e.g. the base station 105. There, e.g. at the base station 105, the feedback resource is configured in the Uu link and/or the first SL between the first UE 101 and the base station 105.

For SL feedback in another Uu link or the second Uu link or the third SL, the SL feedback resource configuration can be configured based on the second Uu link or in the third SL, for instance directly from the base station 105 to the second UE 103, as shown in FIG. 3b. Alternatively, the SL feedback resource can be configured based on the first Uu link and/or the second SL, which in FIG. 3b is based on a transmission of the configuration information from the base station 105 to the first UE 101 and/or based on a SL grant from the first UE 101 to the second UE 103.

According to embodiments of the disclosure, the configuration information can configure whether CBG based transmission is used for SL. For example, there can be DCI format/contents impact including or not on code block group transmission information (CBGTI)/code block group flushing out information (CBGFI) in SL DCI content.

As already described above, embodiments of the disclosure can implement a preemption-based SL URLLC transmission. According to embodiments of the disclosure a signaling can be configured to inform whether preemption is enabled for the SL. In case there is already ongoing eMBB transmission in SL and URLLC traffic needs to be transmitted over the SL, embodiments of the disclosure implement a preemption of the SL eMBB resources for SL URLLC transmission. However, the SL preemption is different with the Uu link. For the Uu DL, the scheduling, data and control transmission are all performed by the base station 105 with no other intermediate link or node involved. For SL: preemption transmission, there may be a centralized scheduling device in the first Uu link or the first SL for the second SL transmission configuration or coordination.

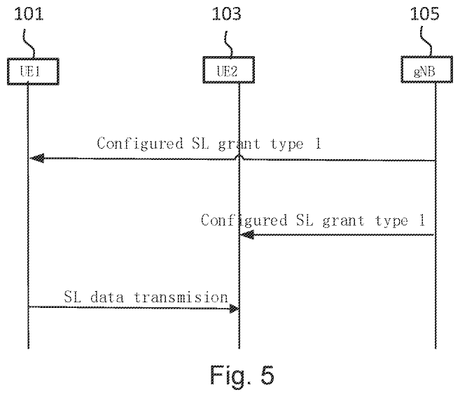

According to embodiments of the disclosure the network 100 can configure/predefine the transmission configuration for the second. SL preemption in the following way (also illustrated in FIG. 5).). The preemption configuration can include resources for preemption. The resources can be time and frequency resources or CB/CBG for preemption. The configured candidate time and frequency resource and/or CB/CBG for preemption usually should be for low priority traffic or for low priority data part and/or control part and/or low priority bits transmission. The preempted resources and/or CB/CBG can be used for SL high priority traffic transmission or Uu link high priority traffic transmission. The preempted resources need to be configured for the first UE 101, i.e. the sidelink transmitting UE, or the second UE 103, i.e. the receiving UE, to avoid some interference or impact on the ongoing traffic e.g. for HARQ retransmission and combination.

When SL control channel is configured to be transmitted in the preempted resources, some configuration for SL control channel transmission should be configured or preconfigured, and this can be done with RRC signaling or MAC CE or both. The configuration for SL control channel transmitted in the preempted resource can include one or more than one of: SL DCI format, aggregation level, time resource configuration or time location in the SL data channel or time resource indication in the assigned time resource for data channel; frequency resource configuration or frequency location in the data channel or frequency indication in the assigned frequency resource for data channel, HARQ feedback resources in the second Uu link or in the third SL for data channel transmitted in the preempted resources. The HARQ feedback resources can also be a preemption of the feedback resource that originally used for the data that is preempted.

When SL data channel is configured to be transmitted in the preempted resources, some configuration for SL data channel transmission should be configured or preconfigured, and this can be done with RRC signaling or MAC CE or both. The configuration for a SL data channel can include one or more than one of: MCS, HARQ process, time and frequency configuration, power control parameter, redundancy version, frequency hopping.

Note usually, part or all of the ongoing SL data channel transmission resources are preempted rather than the control channel resources due to control still useful for the not preempted data scheduling indication. One special case is that both the SL data and control resources are preempted.

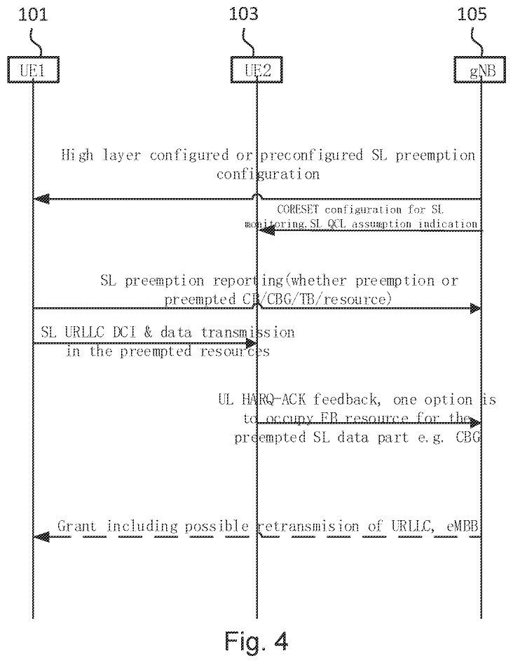

A reporting on preemption information can be reported before or after preemption of the SL transmitting UE. The reporting can include the preempted resource/CB/CBG, In FIG. 4, the transmitting UE is the first UE 101. The base station 105 can use this information for feedback identification/configuration and mitigating the potential interference to other UE. Both SL control and data can be transmitted in the preempted or punctured resources.

Turning in more detail to FIG. 4, in a first operation the first UE 101 receives a high layer signaling on SL preemption configuration including one or more than one of SL DCI format, SL control channel aggregation level, time and frequency resources that can he preempted, CB/CBG configuration that can be preempted, the feedback resources for data. transmission in the preempted resources. Alternatively, the first LIE 101 can report whether preemption or puncturing is implemented and/or when there is a preemption, the preempted or punctured CB/CBG/TB resource (see operation 3 of FIG. 4). On the feedback resource (e.g, HARQ feedback) for the data transmitted in the preempted SL resources, one option is to preempt the feedback resource for the ongoing transmission (e.g. eMBB traffic), e.g. a HARQ feedback resource previously used for the ongoing transmission e.g. eMBB traffic (see operation 5 of FIG. 4), The preemption information may also be piggied back to the base station 105. Another option for the HARQ feedback is to use the configured or reserved HARQ feedback resource in SL for the receiving UE to transmit the feedback to the transmitting UE.

As already described above, embodiments of the disclosure can implement a configured grant-based SL URLLC transmission. According to embodiments of the disclosure, the configured grant-based SL URLLC transmission may have a lower latency than the grant-based SL URLLC transmission. The reason is that it does not have to rely on frequent scheduling requests and the grant procedure. This is because embodiments of the disclosure allow the UE 101 to autonomously transmit the data in the assigned SL resources with the configured formats. In the following reference will be made to L1 signaling, which typically can be PDCCH, but also PBCH, ePDCCH and the like. As illustrated in the following table 10, according to embodiments of the disclosure there can be several different schemes for SL configured grant transmission.

TABLE 10
configured grant: “RRC” or “RRC and PDCCH” or “PDCCH

| Scheme | 1st resource/link | 2nd resource/link | 3rd resource/link |
|---|---|---|---|
| 1 | RRC | | RRC |
| 2 | RRC | RRC/PDCCH | |
| 3 | PDCCH | | PDCCH |
| 4 | RRC + PDCCH | | RRC + PDCCH |
| 5 | PDCCH | PDCCH | |
| 6 | RRC + PDCCH | RRC/PDCCH/RRC + PDCCH | |

Note without loss of the generality some high layer information can also be carried with MAC CE e.g. TCI configuration, not only RRC signaling.

According to embodiments of the disclosure, in a first scheme for SL configured grant transmission there can be a RRC configured grant or configured grant type 1 in the first resource or in the first link for transmission in the second resource or in the second link. The first resource or the first link can be the Uu link or the first SL. The second resource or the second link can be the SL or the second SL.

In an embodiment, a RRC signaling or a separate RRC signaling can be configured for the transmitting UE 101 and the receiving UE 103 respectively on SL transmission resource and format configuration. Alternatively, the first RRC signaling can be transmitted in the first resource or in the first link for transmission configuration in the second resource or in the second link. Alternatively or additionally, the second RRC signaling can be transmitted in the third resource or in the third link for reception or monitoring configuration in the second resource or in the second link.

An exemplary embodiment is shown in FIG. 5, where a separate RRC signaling is configured for the link between the base station 105 and the first UE 101 and the link between the base station and the second UE 103 respectively. The first RRC signaling can be for the UE1 configured grant transmission in SL to the second UE 103. Moreover, the second RRC signaling can be for the UE2 configured grant reception in SL from the first UE 101.

According to embodiments of the disclosure, in a second scheme for SL configured grant transmission there can be a RRC configured grant or configured grant type 1 in the first resource or in the first link for configured grant in the second resource or in the second link. The first resource or the first link can be a Uu link or the first SL. The second resource or the second link can be SL or the second SL.

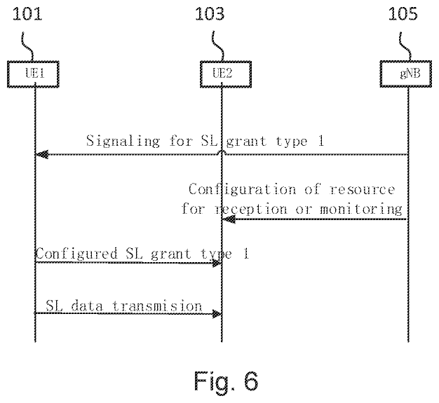

In an embodiment illustrated in FIG. 6, a RRC signaling is configured or received for the first UE 101 in the first resource or in the first link (operation 1 of FIG. 6). The RRC signaling, can indicate to the first UE 101 the content of the configured grant for the second. resource or the second link. The first UE 101 can transmit the configured grant in the second resource or the second link (operation 3 of FIG. 6). The configured grant in the second resource or in the second link can be RRC signaling or L1 signaling or both RRC signaling and L1 signaling. The L1 signaling can be scheduling activation signaling or scheduling release signaling or both and/or with some transmission configuration update or modification. The second UE 103 can receive the configured grant and monitor the associated data transmission. In an embodiment, the second UE 103 may receive separate signaling on the receiving or monitoring time and/or frequency and/or beam configuration for the second link or the second resource. The benefit of this scheme is that it can apply to both in coverage and partial coverage scenario e.g. UE 2 is out of coverage but UE1 is in coverage.

According to embodiments of the disclosure, in a third scheme for SL configured grant transmission there can be a PDCCH configured grant or configured grant type 2 in the first resource or in the first link for transmission in the second resource or in the second link. The first resource or the first link can be a Uu link or the first SI. The second resource or the second link can be the SL or the second SL. The operation of this scheme is similar to the first scheme described above, where the RRC signaling of the first scheme is replaced with a PDCCH configured grant or configured grant type 2.

In an embodiment, separate PDCCH signaling can be configured for the transmitting UE 101 and the receiving UE 103 respectively on the SL transmission resource and format configuration. Alternatively, the first PDCCH signaling can be transmitted in the first resource or in the first link for transmission configuration in the second resource or in the second link. Alternatively or additionally, the 2nd PDCCH signaling can be transmitted in the third resource on in the third link for reception or monitoring configuration in the second resource or in the second link.

According to embodiments of the disclosure, in a fourth scheme for SL configured grant transmission there can be a RRC and PDCCH configured grant in the first resource or in the first link for transmission in the second resource or in the second link. The first resource or the first link can be a Uu link or the first SL. The second resource or the second link can be the SL or the second SL. The operation of this scheme is similar to the first scheme and third scheme described above, where the RRC signaling of the first scheme is replaced with RRC and PDCCH configured grant. in an embodiment, separate combined RRC and PDCCH signaling can be configured for the transmitting UE 101 and the receiving UE 103 respectively on SL transmission resource and format configuration. Alternatively, the first RRC and PDCCH signaling can be transmitted in the first resource or in the first link for transmission configuration in the second resource or in the second link. Alternatively or additionally, the second RRC and PDCCH signaling can be transmitted in the third resource on in the third link for reception or monitoring configuration in the second resource or in the second link.

According to embodiments of the disclosure, in a fifth scheme for SL configured grant transmission there can be a PDCCH configured grant in the first resource or in the first link for configured grant in the second resource or in the second link. The first resource or the first link can be a Uu link or the first SL. The second resource or the second link can be the SL or the second SL.

In an embodiment, a first L1 signaling, e.g. PDCCH or configured grant type 2, can be configured or received for the first UE 101 in the first resource or in the first link. The L1 signaling can indicate to the first UE 101 some or all of the contents of the configured grant for the second resource or the second link.

In an embodiment, a second Ll signaling, e.g. PDCCH or configured grant type 2, can be transmitted from the first UE 101 in the second resource or in the second link. The L1 signaling can configure the scheduling and/or resource allocation for the second resource or the second link transmission.

In an embodiment, the first Li signaling can trigger the activation and/or release for the second L1 signaling. Alternatively a timing, i.e. time duration can be predefined or configured between the triggering of first L1 signaling and the triggering of the second L1 signaling for the activation or release of the second resource or link.

According to embodiments of the disclosure, in a sixth scheme for SL configured grant transmission there can be a RRC and PDCCH configured grant in the first resource or in the first link for configured grant in the second resource or in the second link. The first resource or the first link can be a Uu link or the first SL. The second resource or the second link can be the SL or the second SL.

In an embodiment, a first RRC signaling is configured or received for the first UE 101 in the first resource or in the first link. The first RRC signaling can indicate to the first UE 101 some or all of the contents of the configured grant or RRC signaling for the second resource or the second link. The configured grant for the second resource or the second link can be RRC signaling or PDCCH or both RRC signaling and PDCCH.

In an embodiment, the first UE 101 transmits the configured grant or RRC signaling in the second resource or the second link for scheduling and/or resource allocation of the second resource or the second link. In an embodiment, a first L1 signaling is configured or received for the first UE 101 in the third resource or in the first link. The first L1 signaling can be a configured grant signaling for a second grant or a second L1 signaling.

In an embodiment, the first UE 101 transmits the configured grant, e.g. the second L1 signaling, in the fourth resource or the second link for scheduling and/or resource allocation of the fourth resource or the second link. The first L1 signaling can trigger the activation and/or release for the second L1 signaling. Alternatively a timing, e.g. time duration can be predefined. or configured between the triggering of the first L1 signaling and the triggering of the second LI signaling for the activation or release of the second resource or link.

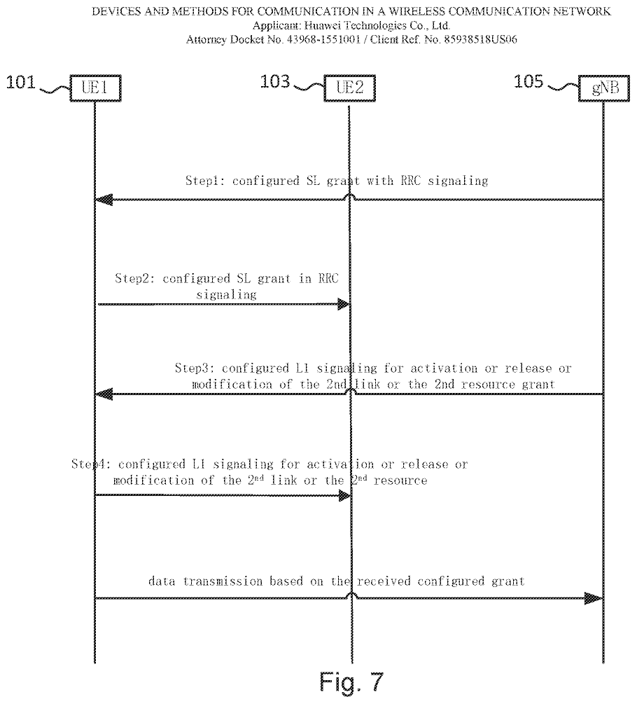

An exemplary embodiment is illustrated. in FIG. 7. Before the SL data transmission based on the SL configured grant (operation 5 of FIG. 7), the following operations, i.e. operations 1 to 4 of FIG. 7, are performed for the configured grant.

Operation 1: Uu RRC signaling transmission indicating SL RRC signaling configuration.

Operation 2: SL RRC signaling transmission indicating some parameters e.g. time domain resource periodicity when the configured grant Type 2 or configured L1 signaling or PDCCH is configured for SL.

Operation 3: Configured L1 signaling for activation or release or modification of SL configured L1 signaling.

Operation 4: SL configured grant L1 signaling transmission indicating the parameters of the SL data transmission.

According to embodiments of the disclosure, the first RRC signaling or the first PDCCH signaling or both the first RRC and the first PDCCH signaling can indicate one or more of the following: the configuration for transmission in the second resource or the second link and/or the configuration or contents of the grant for the second resource or the second link.

According to embodiments of the disclosure, the respective signaling can include one or more of the following: CS-RNTI for all the transmission or just for retransmission; periodicity of the configured grant Type 1; starting symbol and length for time domain allocation; Frequency domain resource allocation; Repetition number; MCS and TBS configuration Redundancy version or redundancy version sequence; DMRS configuration including group number, antenna port, sequence initialization; HARQ process configuration; Precoding information and number of layers; SRS configuration; for data transmission in the second resource or the second link, the HARQ feedback resource in the first resource or first link; for data transmission in the second resource or the second link, the HARQ feedback resource in the second resource or the second link; Unicast or groupcast transmission; Activation or release of the grant of the second link or the second resource from the first link or the first resource; activation or release of the configured grant of the second link or the second resource from the first link or the first resource configured grant; activation or release of the configured grant of the second link or the second resource from the first link or the first resource grant; CS-RNTI of the second link or resource from the first link or resource; a timing, e.g. time duration can be configured between the triggering of the first L1 signaling in the first resource or the first link and the second L1 signaling in the second resource or the second link for the activation or release of the second resource or link.

According to embodiments of the disclosure, the activation or deactivation of the second link or the second resource can use one or more than one of the following: scrambling of DMRS; bit field indication from DCI; special setting of existing hits; and/or CRC scrambling.

According to embodiments of the disclosure, for data transmission in the second resource or the second link, the HARQ feedback resource in the first resource or first link can be based on the PDCCH search space position in the first link or the second link.

Thus, as already described above, embodiments of the disclosure provide an “enhanced” SR message in that the priority/contents of the scheduling request message can include one or more of link usage (Uu/RN/SL), target BLER range/MCS table, latency range, BSR range. The link usage, the range/value of target BLER/MCS table, latency, and/or BSR can be configured/predefined (mapping to logical channel can also be defined). Possible target BIER ranges can include <=1e-3, <=1e-4, <=1e-5, <=1e-6. Possible latency ranges can include <=0.5 ms, <=1 ms, <=3 ms,

Embodiments of the disclosure provide an advantageous cross link indication for SL control and/or data, including SL time domain resource allocation, SL BWP, TCI/QCL assumption, repetition number, HARQ feedback resource in the opposite SL, HARQ feedback resource in another Uu link or sidelink connected with the SL receiving node, whether CBG based transmission for SL. SL DCI format/contents can impact BWP indication, starting frequency, TCI/QCL for data, HARQ timing, whether to include CBGTI/CBGFI and/or whether compact DCI is used.

Embodiments of the disclosure provide an advantageous SL preemption reporting in the Uu link. A signaling can indicate Whether preemption can be used for SL or Uu/Un link. The Uu link can preconfigure the SL preemption control aggregation, data MCS. SL preemption reporting can occur in Uu link.

Embodiments of the disclosure, provide an advantageous cross link configuration of the configured SL grant. Cross link RRC configuration of the configured SL grant type 1 is possible. Cross link RRC configuration and L1 activation/deactivation of configured SL grant type 2 is possible. HARQ feedback resource in another Uu link or sidelink connected with the SL receiving node is possible.

Thus, as already described above, embodiments of the disclosure are directed to a first communication device signaling a second communication device a first transmission configuration and/or a second transmission configuration. The first transmission configuration can indicate the second transmission configuration. The second transmission can be the transmitting configuration and/or the receiving configuration. The configuration can include one or more of the following: a SR configuration, a time domain resource configuration, a BWP configuration, a repetition configuration, a QCL configuration, a HARQ configuration, a preemption configuration, a grant configuration, an activation configuration, and/or a release configuration. The first transmission configuration can be the first link and/or the first resource configuration, while the second transmission configuration can be the second link and/or the second resource configuration. The first link can be a Uu link and the second link can be a SL or both the first and second link are sidelinks.

According to embodiments of the disclosure, the configuration can include the configuration for Uu and/or SL. The configuration can include one or more of: a link usage, the range/value of a target BLERNICS table, a latency/TTI/SCS range or value, a reliability range or value, an availability range or value, and/or a buffer status range or value.

According to embodiments of the disclosure, the configuration can be the SR or priority configuration., The first device can signal the second device the second transmission configuration for data and/or control transmission and/or reception. The control and/or data indication can include one or more than one of: time domain resource, SL BWP, SL resource pool, TCI/QCL assumption, HARQ feedback resource in the opposite SL, and/or whether CBG based transmission for SL is enabled. For the feedback transmission configuration for the third device, the HARQ/CSI feedback resource transmission can be to the first device or in the Uu link or in the first SL. Alternatively, the HARQ/CSI feedback resource transmission can be to the second device or in the SL or in the second SL.

According to embodiments of the disclosure, the first device signaling can indicate one or more than one of: whether preemption can be used for the second device or the second link/resource transmission; whether preemption can be used for the second device transmission to the third device; whether preemption can be used for the second device transmission to the first device. The first device signaling can preconfigure the second device preempted transmission or preempted SL control aggregation and/or data MCS.

According to embodiments of the disclosure, the first device signaling can indicate one or more of the following: configured grant type 1 for the second device transmission and/or the third device reception; triggering the activation and/or release for the second signaling; timing between the first signaling triggering and the second signaling for the activation or release of the second resource or link; activation/deactivation of configured grant type 2 for the second device transmission and/or the third device reception; HARQ and/or CSI feedback resource for transmission of the third device to the first device and/or to the second device.

While a particular feature or aspect of the disclosure may have been disclosed with respect to only one of several implementations, such feature or aspect may be combined with one or more other features or aspects of the other implementations as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Also, the terms “exemplary”, “for example” and “e.g.” are merely meant as an example, rather than the best or optimal. The terms “coupled” and “connected”, along with derivatives may have been used. It should be understood that these terms may have been used to indicate that two elements cooperate or interact with each other regardless whether they are in direct physical or electrical contact, or they are not in direct contact with each other.

Although specific aspects have been illustrated and described herein, it will be appreciated by those of ordinary skill in the art that a variety of alternate and/or equivalent implementations may be substituted for the specific aspects shown and described without departing from the scope of the present disclosure. This application is intended to cover any adaptations or variations of the specific aspects discussed herein.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

Many alternatives, modifications, and variations will be apparent to those skilled in the art in light of the above teachings. Of course, those skilled in the art readily recognize that there are numerous applications of the disclosure beyond those described herein. While the present disclosure has been described with reference to one or more particular embodiments, those skilled in the art recognize that many changes may be made thereto without departing from the scope of the present disclosure, It is therefore to be understood that within the scope of the appended claims and their equivalents, the disclosure may be practiced otherwise than as specifically described herein.

1. A user equipment for communication in a wireless communication network, the user equipment comprising:
at least one processor; and
a non-transitory memory storing instructions, which when executed by the at least one processor, cause the at least one processor to:
receive configuration information from a base station using a first communication resource, wherein the configuration information defines a communication configuration of the user equipment using a second communication resource for communicating with at least one of the following:
the base station, wherein the configuration information comprises at least one of a scheduling request (SR) or a priority configuration; or
a further user equipment , wherein the configuration information comprises at least one of the following: time domain resource configuration, bandwidth part (BWP) configuration, resource pool configuration, repetition configuration, quasi-colocation (QCL) configuration, hybrid ARQ (HARM) configuration, preemption configuration, grant configuration, activation configuration, or release configuration.

2. The user equipment according to claim 1, wherein the communication configuration received from the base station comprises a setting of a communication parameter including one or more of the following parameters: a link usage, a range or value of at least a target block error rate (BLER) or modulation and coding scheme (MCS) table, at least one of a latency, transmit time interval (TTI) or subcarrier spacing (SCS) range or value, a reliability range or value, an availability range or value, or a buffer status range or value.

3. The user equipment according to claim 1, wherein the instructions further cause the at least one processor to transmit a schedule request (SR) message to the base station based on at least one of the SR or priority configuration information received from the base station.

4. The user equipment according to claim 3, wherein the instructions further cause the at least one processor to at least encode a communication parameter in the SR message as a bit sequence or by using one or more third communication resources of a plurality of third communication resources for transmitting the SR message to the base station.

5. The user equipment according to claim 4, wherein the instructions further cause the at least one processor to:
receive from the base station at least one of an encoding scheme, a correspondence between the communication parameter in the SR message and the bit sequence, or the one or more third communication resources; and
encode the communication parameter in the SR message based on at least the encoding scheme or the correspondence provided by the base station.

6. The user equipment according to claim 1, wherein the configuration information defines the communication configuration of the user equipment using the second communication resource for communicating with the further user equipment, and wherein the configuration information comprises one or more of the following: time domain resource configuration, a sidelink (SL) BWP, a resource pool, a transmission configuration indication (TCI) /QCL assumption, a repetition number, at least one of a HARQ feedback resource for SL data, a channel state information (CSI) feedback resource for SL channel in at least one of Uu link, another sidelink, or an opposite sidelink, or at least one of a code block (CB) or code block group (CBG) configuration in SL.

7. The user equipment according to claim 1, wherein the instructions further cause the at least one processor to:
communicate with the further user equipment using a fourth communication resource, wherein the user equipment is configured to preempt based on the preemption configuration of the fourth communication resources or
use the second communication resource for communicating with the further user equipment.

8. The user equipment according to claim 7, wherein the preemption configuration includes one or more of the following: information on whether SL preemption is enabled or disabled, one or more of preempted SL resources, one or more of SL resources for preemption, at least a SL control or data configuration in the one or more of preempted SL resources, a SL preemption request configuration, or a SL preemption reporting configuration.

9. The user equipment according to claim 1, wherein the communication configuration received by the user equipment comprises one or more of the following:
a configured grant transmitted in one of a first resource, a first sidelink (SL), and a first Uu link for the configuration of a second configured grant transmitted in the second communication resource or in a second SL;
a configured radio resource control (RRC) grant transmitted in the first SL or in the first Uu link for the configuration of a second configured RRC grant or a second configured physical downlink control channel (PDCCH) grant transmitted in the second communication resource or in the second SL;
an activation or release for the second configured grant with a first grant or a first configured grant;
a timing between the first grant transmitted in one of the first communication resource, the first Uu link, and the first SL and the second configured grant transmitted in the second communication resource or in the second SL for the activation or release of the second configured grant;
an activation or release of a configured PDCCH grant based on the first grant transmitted in one of the first communication resource, the first Uu link, and the first SL for the second communication resource or second SL transmission or reception; or
for configured grant scheduled data transmission in the second SL, a HARQ feedback resource in another Uu link or a third SL or in an opposite SL.

10. A base station for communication in a wireless communication network, the base station comprising:
at least one processor; and
a non-transitory memory storing instructions, which when executed by the at least one processor, cause the at least one processor to:
transmit configuration information to a user equipment using a first communication resource, wherein the configuration information defines a communication configuration of the user equipment using a second communication resource for communicating with at least one of the following:
the base station, wherein the configuration information comprises at least one of a scheduling request (SR) or priority configuration; or
a further user equipment, wherein the configuration information comprises at least one of the following: time domain resource configuration, bandwidth part (BWP) configuration, resource pool configuration, repetition configuration, quasi-colocation (QCL) configuration, hybrid ARQ (HARQ) configuration, preemption configuration, grant configuration, activation configuration, or release configuration.

11. The base station according to claim 10, wherein the communication configuration transmitted to the user equipment comprises a setting of a communication parameter including one or more of the following parameters: a link usage, a range or value of at least a target block error rate (BLER) or modulation and coding scheme (MCS) table, at least one of a latency, transmission time interval (TTI) or sub-carrier spacing (SCS) range or value, a reliability range or value, an availability range or value, or a buffer status range or value.

12. The base station according to claim 10, wherein the instructions further cause the at least one processor to receive a SR message from the user equipment based on at least one of the SR or priority configuration information transmitted to the user equipment .

13. The base station according to claim 12, wherein the instructions further cause the at least one processor to at least decode a communication parameter in the SR message, which is a bit sequence included in the SR message, or based on one or more third communication resources of a plurality of third communication resources used for receiving the SR message from the user equipment.

14. The base station according to claim 13, wherein the instructions further cause the at least one processor to provide to the user equipment at least one of an encoding scheme, a correspondence between the communication parameter in the SR message and the bit sequence, or the one or more third communication resources for allowing the user equipment to encode the communication parameter in the SR message based on at least the encoding scheme or the correspondence.

15. The base station according to claim 10, wherein the configuration information defines the communication configuration of the user equipment using the second communication resource for communicating with the further user equipment, and wherein the configuration information comprises one or more of the following: a time domain resource, a sidelink (SL) BWP, a resource pool, a transmission configuration indication (TCI)/QCL assumption, a repetition number, at least one of a HARQ feedback resource for SL data, a channel state information (C SI) feedback resource for SL channel in at least one of Uu link, another sidelink, or an opposite sidelink, or at least one of a code block (CB) or code block group (CBG) configuration in SL.

16. The base station according to claim 10, wherein the communication configuration transmitted by the base station comprises at least one of the following:
a configured grant transmitted in a first resource or in a first sidelink (SL) for the configuration of a second configured grant transmitted in the second communication resource or in a second SL;
a configured radio resource control (RRC) grant transmitted in a first SL for the configuration of a second configured RRC grant or a second configured physical downlink control channel (PDCCH) grant transmitted in the second communication resource or in the second SL;
an activation or release for the second configured grant with a first grant or a first configured grant;
a timing between the first grant transmitted in one of the first communication resource, a Uu link, and the first SL and the second configured grant transmitted in the second communication resource or in the second SL for at least one of activation or release of the second configured grant;
an activation or release of a configured PDCCH grant based on the first grant transmitted in one of the first communication resource, the Uu link, and the first SL for the second communication resource or second SL transmission or reception; or
for configured grant scheduled data transmission in the second SL, a HARQ feedback resource in another Uu link or in a third SL or in an opposite SL.
